(19) United States
(12) Patent Application Publication
(10) Pub. No.: US 2026/0170063 A1
(43) Pub. Date: Jun. 18, 2026

(54) COMPUTER-IMPLEMENTED METHOD AND SYSTEM FOR AUTOMATING DOCUMENT ANALYSIS PROCESS

(71) Applicant: Quantiphi, Inc, Marlborough, MA (US)

(72) Inventors: Dagnachew Birru, Marlborough, MA (US); Venkata Sai Prakash Mukkamala, Mumbai (IN); Ganesh Laxman Parab, Mumbai (IN); Meghana Veeramalla, Mumbai (IN); Vishal Vaddina, Toronto (CA)

(73) Assignee: Quantiphi, Inc, Marlborough, MA (US)

(21) Appl. No.: 18/978,452

(22) Filed: Dec. 12, 2024

(51) Int. Cl. G06F 16/93; G06F 16/901; G06F 16/903

(52) U.S. Cl. CPC G06F 16/93; G06F 16/901; G06F 16/90335

(57) ABSTRACT

Disclosed is computer-implemented method for automating document analysis process. Method comprises: receiving plurality of documents into document classification module; processing each document using document classifier to classify each document into related document (RD) or unrelated document; when given document is classified as RD: segmenting given document into plurality of data chunks (PDC) comprising text portions, generating semantic embeddings (SE) for each data chunk of PDC, indexing PDC and corresponding SE thereof, in database, retrieving SE of PDC for summarizing the given document based on: document identifier, subject, generating subject-based query embedding, performing similarity search of subject-based query embedding to retrieve SE of data chunk related to subject, and passing retrieved SE to large language model (LLM) to generate summary of given document.

### FIELD OF TECHNOLOGY

The present disclosure relates to a general field of document analysis and automated summarization or information management for the identification and exclusion of documents lacking a related data. Specifically, the present disclosure relates to a computer-implemented method and a system for automating document analysis process.

### BACKGROUND

In recent years, the increasing volume of unstructured textual data has led to a growing demand for automated systems that can extract, synthesize, and present information in a coherent and concise format. Industries such as healthcare, finance, and pharmaceuticals often need to analyse complex documents and derive meaningful insights without manual intervention. This is particularly critical in high-stakes domains where the accuracy of information directly impacts the decision-making process. Summarizing large volumes of information accurately and efficiently requires a system that can not only identify key details but also organize them in a way that is easily accessible and factually correct, thus aiding in timely and effective decision-making.

Existing solutions to document summarization and information extraction include rule-based systems and machine learning models that attempt to identify relevant portions of text and condense them into a summary. The aforementioned rule-based systems rely on predefined templates and keywords, which can provide structure but often lacks flexibility and scalability. On the other hand, the machine learning models, particularly deep learning-based natural language processing (NLP) models, have made significant advances in text generation and summarization. However, the aforementioned models are largely limited by their reliance on large datasets for training, which may not fully capture the nuances of domain-specific content. Additionally, such models tend to struggle with fact-checking and ensuring the accuracy of generated summaries, often producing outputs that lack contextual precision or omit critical information.

Despite these advancements, the aforementioned existing solutions face considerable limitations. For instance, many NLP models are prone to generating “hallucinations,” where the model produces information that appears plausible but is factually incorrect or inconsistent. This is particularly problematic in regulated industries like pharmaceuticals, where factual accuracy and regulatory compliance are paramount. Furthermore, the existing solutions often lack mechanisms for iterative refinement and quality assessment, resulting in summaries that may fail to meet predefined quality standards and the inability to accurately control and verify the generated content.

Therefore, in the light of the foregoing discussion, there exists a need to overcome the aforementioned drawbacks.

### BRIEF SUMMARY OF THE DISCLOSURE

The present disclosure provides a computer-implemented method and a system to ensure that automating document analysis process improves identification and exclusion of documents lacking related data and summarize the documents according to predetermined regulatory formats. The present disclosure seeks to provide a solution to the existing problem of how to simplify and automate a document analysis process to ensure effective summarization of the document and finding related document to ensure, for example, post market safety of pharmaceuticals. The aim of the present disclosure is to provide a solution that overcomes at least partially the problems encountered in the prior art and provide an improved computer-implemented method and system for automating document analysis process. The aim of the present disclosure is achieved by a computer-implemented method and a system for automating document analysis process using document classification, summarization, question answering and the sequential operation therebetween.

In one aspect, the present disclosure provides a computer-implemented method for automating document analysis process. The computer-implemented method comprises receiving a plurality of documents from a user, into a document classification module. Moreover, the computer-implemented method comprises processing each document from amongst the plurality of documents using a document classifier to classify each document into a related document or an unrelated document, based on information present in each document. Furthermore, the computer-implemented method comprises, when a given document is classified as the related document, dividing the given document into a plurality of data chunks by segmenting the given document into smaller text portions, generating, using a transformer-based language model, semantic embeddings for each data chunk of the plurality of data chunks, indexing the plurality of data chunks with the corresponding semantic embeddings thereof, in a database, retrieving the semantic embeddings of the plurality of data chunks for summarizing the given document based on at least one of: a document identifier, a subject, generating a subject-based query embedding of the subject, performing a similarity search of the subject-based query embeddings in the database to retrieve semantic embeddings of the at least one data chunk related to the subject, and passing the retrieved semantic embeddings of the at least one data chunk to at least one large language model (LLM) to generate a summary of the given document, based on the subject.

Beneficially, the embodiments of the present disclosure provide a simplified, efficient and automated computer-implemented method that ensures managing the document analysis process effectively, with a primary focus on efficiently handling and summarizing the related information in large volumes of documents. Moreover, the computer-implemented method effectively handles the large volumes of data by classifying the documents into related documents and unrelated documents that offers significant advantages in terms of accuracy, efficiency, scalability, and usability and reduces the load to process entire document set, that further increases the processing speed. By discarding the unrelated documents, the computer-implemented method reduces noise and improves the accuracy of the information extracted from the database. Furthermore, the chunking technique facilitates efficient processing by breaking down lengthy documents into manageable sections, which can then be processed individually. This continuous learning mechanism ensures that the system evolves over time, becoming more adept at selecting the most appropriate roles and responses in future interactions. Furthermore, the use of large language model (LLM) for both summarization and query response generation enhance the flexibility and depth of information retrieval, making the computer-implemented method adaptable to a variety of document analysis and document vigilance scenarios. Furthermore, the feedback loop facilitates ongoing refinement of responses, ensuring that the process remains responsive to user needs and regulatory standards.

In another aspect, provides a system for automating document analysis process. The system comprises at least one processor. The at least one processor is configured to receive a plurality of documents based on a user input, into a document classification module. Moreover, the at least one processor is configured to process each document from amongst the plurality of documents using a document classifier to classify each document into a related document or an unrelated document, based on information present in each document. Furthermore, the at least one processor, when a given document is classified as the related document, is configured to segment the given document into a plurality of data chunks comprising text portions. Furthermore, the at least one processor is configured to generate, using a transformer-based language model, semantic embeddings for each data chunk of the plurality of data chunks. Furthermore, the at least one processor is configured to index the plurality of data chunks and the corresponding semantic embeddings thereof, in a database. Furthermore, the at least one processor is configured to retrieve the semantic embeddings of the plurality of data chunks for summarizing the given document based on at least one of: a document identifier, a subject. Furthermore, the at least one processor is configured to generate a subject-based query embedding of the subject. Furthermore, the at least one processor is configured to perform a similarity search of the subject-based query embedding in the database to retrieve semantic embeddings of the at least one data chunk related to the subject. Furthermore, the at least one processor is configured to pass the retrieved semantic embeddings of the at least one data chunk to at least one large language model (LLM), to generate a summary of the given document, based on the subject.

The system achieves all the advantages and technical effects of the computer-implemented method of the present disclosure. Herein, the system enables the processor to automate the document analysis process and allows the user to query the database for the required information and view contextually accurate responses, improving usability and accessibility to the desired information.

It has to be noted that all devices, elements, circuitry, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

Additional aspects, advantages, features, and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not too scaled. Wherever possible, like elements have been indicated by identical numbers.

Embodiments of the present disclosure will now be described, by way of example only, with reference to the following diagrams wherein:

FIG. 1 is a flow chart of a computer-implemented method for automating document analysis process, in accordance with an embodiment of the present disclosure;

FIG. 2 is a flow chart depicting an exemplary scenario for an automating document analysis process, in accordance with an embodiment of the present disclosure;

FIG. 3 is a schematic illustration of an exemplary scenario of a document classification, in accordance with an embodiment of the present disclosure;

FIG. 4 is a schematic illustration of an exemplary scenario of a question-answering process, in accordance with an embodiment of the present disclosure;

FIG. 5 is a schematic illustration of an exemplary scenario of summarization, in accordance with an embodiment of the present disclosure;

FIG. 6 is a schematic illustration depicting steps of an exemplary scenario of a document-based summarization, in accordance with an embodiment of the present disclosure;

FIG. 7 is a schematic illustration depicting steps of an exemplary scenario of a subject-based summarization, in accordance with an embodiment of the present disclosure; and

FIG. 8 is a schematic illustration of a system for automating document analysis process, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF THE DISCLOSURE

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

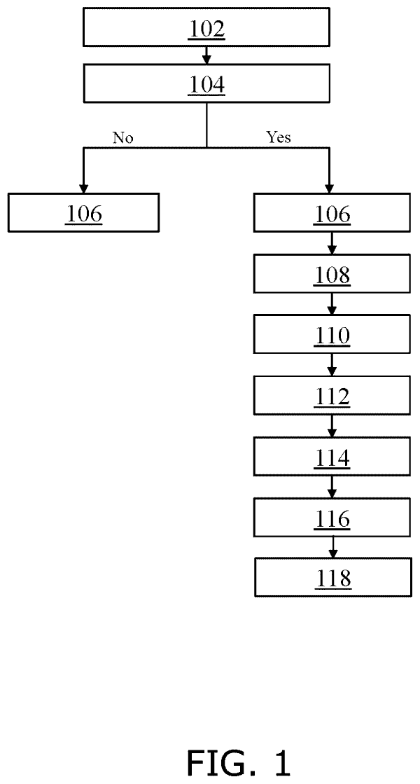

FIG. 1 is a flowchart 100 of a method for automating document analysis process, in accordance with an embodiment of the present disclosure. The method comprises steps from 102 to 118.

Throughout the present disclosure, the term “document analysis” refers to a process that involves systematic collection, analysis, and interpretation of data related to a document such as document related to the safety and effectiveness of pharmaceuticals. Beneficially, the document analysis process ensures efficient and timely analysis of lengthy documents in reduced time period. Additionally, automating the document analysis process ensures intelligent document processing and verification process that is suitable for regulated industries. It will be appreciated that the automating the document analysis process via the computer-implemented method streamlines the aforementioned tasks, enabling more efficient and accurate handling of large volumes of data (for example, pharmacovigilance related data, finance related data and the like) while reducing human error and improving response times, and also improving patient safety and supporting regulatory compliance. It will also be appreciated that the automation helps pharmaceutical companies, financial sectors (such as banks, NBFCs) and healthcare organizations quickly respond to adverse event queries, which is critical in high-stakes situations where timely and accurate information is vital.

At step 102, a plurality of documents is received from a user, into a document classification module. Throughout the present disclosure, the term “user” refers to an individual, entity, or an organization that submits documents for processing. Notably, the user may include a pharmacovigilance specialist, a healthcare professional, a regulatory compliance officer, a finance professional or any authorized individual responsible for reviewing the documents. Throughout the present disclosure, the term “documents” refers to a record or a file that contains information such as monitoring the safety and efficacy of pharmaceutical products, financial frauds, financial transactions and the like. Typically, the plurality of documents may include case reports of patient's diagnoses, treatments and outcomes, report of client transactions, literature reviews, internal memos, clinical trial data, product quality complaints and the like. The term “document classification module” refers to an artificial intelligent (AI) module that is designed to classify the plurality of documents based on their content. Notably, the document classification module is responsible for analysing each document within the plurality of documents. Moreover, the document classification module employs natural processing language (NLP) and machine learning algorithms to automate the classification process. It will be appreciated that the document classification module enhances efficiency and accuracy in the document analysis workflows by automatically filtering and sorting large volumes of the plurality of documents, thus reducing the need for manual review and enabling faster identification of critical safety information.

At step 104, each document from amongst the plurality of documents is processed using a document classifier to classify each document into a related document or an unrelated document, based on information present in each document. Throughout the present disclosure, the term “related document” refers to a document that contains information related to the field of the user query such as adverse effects of drugs or drug safety incidents, financial frauds and the like. The term “unrelated document” refers to a document that lacks information related to the field of the user query such as adverse effects of drugs or drug safety incidents, financial fraud and the like. Notably, the non-adverse event document is less relevant for adverse event analysis. Throughout the present disclosure, the term “document classifier” refers to a computational tool or an algorithm that is specifically designed to analyse the plurality of documents and distinguish the plurality of documents into the related document or the unrelated document. Notably, the document classifier utilizes natural language processing (NLP) techniques to understand wide range of scientific text. It will be appreciated that the plurality of documents is pre-processed before performing the analysis by the document classifier thereon. Optionally, during the pre-processing stage, the plurality of documents is analysed by a pretrained language model such as SciBERT, that generates paragraph embeddings for each paragraph of the plurality of documents. Furthermore, by examining the content or information of each document, the document classifier identifies key terms, phrases, and patterns associated with adverse events, such as mentions of specific drug reactions, patient symptoms, and safety concerns, transaction reports, transaction's place. Subsequently, the document classifier categorizes each document amongst the plurality of documents as either as the related document or the unrelated document. Optionally, each document is pre-processed by the computer-implemented method after the document is received in the classification module. Moreover, during the preprocessing each document is divided into smaller and manageable units of data chunks. The data chunks are transformed into dense vector representations. The dense vector representation of embeddings in a database for efficient search and retrieval. Concurrently, the document classifier analyses the document to detect an event such as adverse events. A technical effect is that the classification of each document into the related document or the unrelated document streamlines the review process and ensures that the reviewer focus only on relevant documents, saving time and resources. Optionally, for an example, the document classification process reduces the burden on the reviewer and enhances efficiency in the review process by reducing in processing time for summarization (will be discussed later) by 80% and reducing the computational cost for question answering (will be discussed later) by 75%.

In an implementation, the document classifier comprises a machine learning model to classify each document into the related document or the non-related document. Herein, the term “machine learning model” refers to an algorithm or mathematical framework that is trained to automatically classify the documents as either the related documents or the unrelated documents based on the content of each document. Moreover, the document classifier uses historical data to understand the characteristics of documents that are likely to contain adverse event information, ensuring that critical safety-related documents are flagged for further analysis. It will be appreciated that machine learning model automates the process of distinguishing between documents containing adverse event data and those that do not, eliminating the need for manual review. A technical effect is that the machine learning model can scale to process large volumes of documents in a short period, making it suitable for handling the substantial and continuously growing volume of data such as in the pharmaceutical industry, financial sector and the like.

When a given document is classified as the related document. The at step 106, the given document is divided into a plurality of data chunks by segmenting the given document into smaller text portions. Throughout the present disclosure, the term “data chunks” refers to smaller, discrete portions or segments of text that are derived from the given document. Notably, the plurality of data chunks is created by dividing the given document into manageable sections by segmenting sentences, paragraphs, or the like logical text divisions. Throughout the present disclosure, the term “segmenting” refers to a process of dividing a large document into smaller, discrete portions or sections based on logical or linguistic boundaries, such as sentences, paragraphs, or thematic sections. Notably, the segmenting is guided by predefined rules or algorithms that analyse the structure and content of the given document to create manageable and meaningful segments. Moreover, the primary purpose of creating the plurality of data chunks is to facilitate efficient processing, analysis, and retrieval of specific information within the given document, enabling targeted handling. It will be appreciated that the plurality of data chunks enables more granular handling, such as identifying the relevant details at the sentence or paragraph level.

In an implementation, when a given document is classified as the unrelated document, the unrelated document is discarded. Herein, purpose of this step is to discard or exclude the unrelated document form further analysis in the document analysis process. Moreover, by discarding the unrelated document, the method can focus on documents with genuine safety concerns, enhancing efficiency and relevance in the document analysis. It will be appreciated that the by discarding the unrelated document from the plurality of documents reduces the computational load and processing time, which allows the computer-implemented method to focus more effectively on documents that have a higher likelihood of containing a relevant information. Additionally, it optimizes storage and processing resources, as only pertinent data is retained for further evaluation.

At step 108, semantic embeddings are generated, using a transformer-based language model, for each data chunk of the plurality of data chunks. Throughout the present disclosure, the term “semantic embeddings” refers to numerical representations of the text data that capture the meaning, context, and relationships between words and phrases within each data chunk of the plurality of data chunks. Notably, the semantic embeddings allow the method to perform searches based on conceptual similarity rather than mere keyword matching, which enhances the relevance and accuracy of the search results. Throughout the present disclosure, the term “transformer-based language model” refers to a type of deep learning model architecture designed for processing and understanding natural language by transforming sequences of words or phrases into semantic embeddings. Notably, the transformer-based language model uses attention mechanisms to capture the relationships and contextual relationships between words in a text, allowing it to generate a nuanced, context-aware understanding of each segment of data. It will be appreciated that the transformer-based language model converts textual information into vectors in a high-dimensional space where semantically similar content is positioned closer together. The vectorized form allows the computer-implemented method to effectively compare, search, and retrieve relevant information based on meaning rather than exact wording. It will also be appreciated that the semantic embeddings facilitate to perform searches based on conceptual similarity rather than mere keyword matching, which enhances the relevance and accuracy of the search results.

At step 110, the plurality of data chunks and the corresponding semantic embeddings thereof, is indexed in a database. Throughout the present disclosure, the term “indexing” refers to a process of organizing and storing the plurality of data chunks along with the corresponding semantic embeddings in a structured format. Notably, the indexing involves assigning each data chunk and its corresponding semantic embedding a position in the database that allows for easy searching and sorting based on similarity to user queries or other data entries. Throughout the present disclosure, the term “database” refers to a distributed, search-optimized database specifically designed to store, search, and analyse large volumes of structured and unstructured data in near real-time. Typically, the database is used to store the plurality of data chunks alongside their semantic embeddings, facilitating rapid retrieval and similarity searches based on the embedded meanings of the text rather than exact keyword matches. It will be appreciated that the database's inverted indexing enables fast search operations, which is essential for handling large datasets and providing quick responses to user queries. Moreover, with the semantic embeddings indexed in the database, the large language model can retrieve the plurality of data chunks that are contextually similar to queries, even if the exact wording differs. The database is built to handle distributed data across multiple nodes, which makes it suitable for large-scale pharmacovigilance applications, financial fraud detection, legal document analysis, healthcare data management, supply chain optimization, customer service optimization, cybersecurity incident analysis and the like, where documents and data continuously grow over time.

At step 112, the semantic embeddings of the plurality of data chunks is retrieved for summarizing the given document based on at least one of: a document identifier, a subject. Throughout the present disclosure, the term “document identifier” refers to a unique code, number or string assigned to each document that enables distinct identification and reference to that specific document. Notably, the document identifier is used to accurately and efficiently retrieve the data chunks associated with the document from the database. It will be appreciated that the document identifier facilitates to locate and retrieve data chunks belonging to a specific document without ambiguity. Additionally, the document identifier facilitates to retrieve only the data chunks from the given document and enhances retrieval accuracy by avoiding irrelevant data. Throughout the present disclosure, the term “subject” refers to a specific theme, topic, or primary focus area within the given document that serves as a basis for retrieving the relevant data chunks for summarization. Notably, the subject entered by the user may represent critical topics, for example, specific adverse drug reactions, patient demographics, or other significant medical events documented in the reports. Throughout the present disclosure, the term “summarizing” refers to a process of condensing and simplifying the content of the given document by extracting the most relevant information, while preserving the essential meaning and context. Typically, the summarization process may include aggregating the plurality of data chunks and insights from the given document's text and organizing them in a concise form, It will be appreciated that the subject filters the content of the given document to retrieve only the sections or the plurality of data chunks most pertinent to the selected subject. Moreover, the subject provides context for targeted information retrieval. It will also be appreciated that retrieving specific data chunks based on the at least one of: the document identifier, the subject allows to narrow down the content for targeted analysis and summarization. This approach enhances efficiency by focusing on relevant sections to extract concise information that aligns with the user's focus, such as specific drug reactions or demographics, without scanning through the entire document.

At step 114, a subject-based query embedding of the subject is generated. Throughout the present disclosure, the term “subject-based query embedding” refers to a vector representation of the subject provided by the user. Notably, the subject-based query embedding captures the semantic meaning or context of the subject. Throughout the present disclosure, the term “embedder” refers to a machine learning model or algorithm that converts the subject-based query specifically textual data into a numerical representation such as vector embeddings. Typically, the subject-based query embeddings are a set of vectors that is a numerical representation of the subject (such as a particular adverse event, drug, financial fraud, banking transactions or pharmacovigilance topic) based on its semantic context. It will be appreciated that the subject-based query embedding is designed to represent the meaning of the subject in a way that captures its relationship with other data, helping to match the subject to relevant information stored in the database. It will also be appreciated that the subject-based query embedding generated by the embedder helps to match the user query to relevant data chunks by comparing the subject-based query embedding with the embeddings of data chunks in the database.

At step 116, a similarity search of the subject-based query embedding is performed in the database to retrieve semantic embeddings of the at least one data chunk related to the subject. Throughout the present disclosure, the term “similarity search” refers to a search technique that is used to find the semantic embeddings of the at least one data chunk that is semantically or contextually similar to the subject. Notably, the similarity search may include querying the database to retrieve the at least one data chunk based on semantic embeddings of the at least one data chunk. It will be appreciated that a specialized dense retriever is used to retrieve the at least one data chunk related to the subject from amongst the plurality of data chunks. Additionally, the specialized dense retriever retrieves at least one data chunk from the database that extends beyond individual documents and captures a contextual panorama that is extended over multiple documents.

At step 118, the retrieved semantic embeddings of the at least one data chunk is passed to a large language model (LLM) to generate a summary of the given document, based on the subject. Throughout the present disclosure, the term “large language model (LLM)” refers to a type of artificial intelligence (AI) model that is designed to understand and generate human-like text based on given vast amount of training prompts or queries. Typically, the Large Language Model (LLM) is based on deep learning architectures such as transformers. Notably, the LLM is trained on diverse text data to understand linguistic patterns, context and meaning, and can generate responses to natural language queries, carry out conversations, translate text, summarize information, and the like. Throughout the present disclosure, the term “summary” refers to a concise and coherent representation of the key information and essential content derived from the given document. Moreover, the LLM is fed with the retrieved semantic embeddings of the at least one data chunk. Subsequently, the LLM processes the retrieved at least one data chunk and utilizes its language understanding capabilities to summarize the given document based on the subject. Furthermore, based on the subject provided, the LLM produces the summary that captures key information, relevant to the document analysis process. The summary is intended to be concise while retaining the critical details such as related to adverse events or other pharmacovigilance information. Optionally, in an example, a lengthy case report (15 pages) detailing a complex adverse event with multiple contributing factors needed to be summarized. A specific query focused on the patient's cardiovascular response was made. The subject-based summarization quickly isolated the cardiovascular-related details (approximately 2 paragraphs) directly answering the query. This reduced the review time for the pharmacovigilance professional from an estimated 30 minutes to under 5 minutes. It will also be appreciated that the subject-based summarization facilitates handling diverse contextual nuances, allowing for a more comprehensive and accurate summarization tailored to regulatory standards.

In an implementation, the method further comprises receiving the document identifier corresponding to a target document; retrieving the target document associated with the document identifier from the database, using a dense retriever; segmenting the target document into a plurality of data chunks comprising text portions; passing the plurality of data chunks to the LLM to generate corresponding plurality of chunk summaries thereof; aggregating the plurality of chunk summaries to generate a summary in a predetermined format, using the LLM; displaying the generated summery in the predetermined format as an output to the user; and receiving a user feedback to the output.

Herein, the term “target document” refers to a related document within the database that is identified by the corresponding document identifier. Notably, the document identifier is related to the target document that requires summarization. Optionally, the large language mode utilizes RAG pipeline or any other custom pipeline to summarize the target document. Herein, the term “dense retriever” refers to a specialized retriever that is used to locate and extract the target document from the database. It will be appreciated that the retrieval of the target document and the content of the target document is crucial for the summarization of the target document. The text portions of the target document is divided into the plurality of data chunks, wherein each data chunk of the plurality of data chunks represents a specific section of the target document. Each chunk captures a section of the target document to ensure that summarization is contextually accurate. Moreover, each chunk is within the LLM's maximum context size. Herein, the term “section” refers to a portion or a part of the target document. Typically, the section may include a paragraph related to the text of the target document. Each section is designed to contain relevant information around a particular topic or type of data, allowing for targeted processing and retrieval of information from specific parts of the target document. Herein, the term “data chunk summary” refers to a concise representation or a summary generated for the individual data chunk (smaller segmented text portion) corresponding to the section of the target document. The plurality of the data chunk summaries distils key points or information specific to the corresponding chunk, capturing essential insights without processing the entire target document. The plurality of data chunk summaries allows for efficient and focused information retrieval. It will be appreciated that by dividing the target document into the plurality of data chunks and preparing a summary of each chunk individually, the LLM ensures detailed yet precision extraction of information and reduces the risk of mission critical information. Moreover, generating the plurality of data chunk summaries enables parallel processing by the LLM as the at least one data chunk can be summarized independently, accelerating the overall summarization process and minimizes the workload on the LLM. Herein, the term “aggregating” refers to a process of combining multiple chunk summaries. Notably, the aggregation process may involve integrating the individually generated data chunk summaries form each section of the target document. It will be appreciated that the plurality of data chunk summaries is passed to the LLM, wherein the LLM summarizes the already condensed chunk summaries to summarize the target document into a single summary. Herein, the term “summary” refers to a condensed representation of the target document. Notably, the summary is generated by combining insights from plurality of data chunk summaries. Herein, the term “predetermined format” refers to specific layout or structure that is used to represent the summary to the user. The predetermined format is set in advance based on the requirements for displaying the summarized information to the user. Herein, the term “output” refers to a final summarized document displayed to the user in the predetermined format. It will be appreciated that the predetermined format may include FDA's MedDRA coding system. Advantageously, the LLM ensures that the summary matches the predetermined format. It will also be appreciated that the summary saves time as well as ensures consistency in information presentation and meeting the requirements of the regulatory compliance. Herein the term “user feedback” refers to feedback provided by the user to enable iterative refinement of the document-based summarization process. Notably, the user feedback allows user validation of the generated summary, providing an opportunity for the refinement in case there is an error, or an inconsistency is present in the generated summary. Moreover, the user feedback may include information related to deficiencies present in the generated summary. Optionally, for an example, a lengthy case report (15 pages) detailing a complex adverse event with multiple contributing factors needed to be summarized. A specific query focused on the patient's cardiovascular response was made. The multi-pass approach intelligently captured the key elements of the entire case report, then the subject-based summarization quickly isolated the cardiovascular-related details (approximately 2 paragraphs) directly answering the query. This reduced the review time for the user such as pharmacovigilance professional from an estimated 30 minutes to under 5 minutes. A technical effect is that the document-based summarization significantly reduces the time and cognitive load required for the user to interpret large documents by providing concise, accurate summaries in a standardized format. Additionally, the user feedback facilitates adaptive learning, allowing the system to continuously refine its summarization process based on real-time user input, enhancing both usability and user satisfaction.

In an implementation, the computer-related method further comprises receiving a user query from the user; generating a user query embedding; performing a similarity search of the user query embedding in the database to retrieve semantic embeddings of the at least one data chunk related to the user query; forwarding the user query embedding and the subject-based query embedding from the database to a Factual Evidence (FE) engine; verifying a relevance of the user query embedding and the subject-based query embedding using a cross encoder; passing the verified user query embedding and the subject-based query embedding along with a predefined instruction prompt to at least one LLM to generate a response for the user query; displaying the generated response to the user via a user interface; and enabling the user to provide, via the user interface, a feedback to the LLM for adjusting the generated response based on the feedback. Herein, the term “user query” refers to a query or search input received from the user. Typically, the user query seeks specific information related to the adverse events from the database. Notably, the user query may be in a form of a question, keyword, phrase, or subject matter such as financial fraud related queries aimed at retrieving insights or details regarding potential adverse effects associated with financial fraud or the summary responses generated by the LLM. It will be appreciated that the user query is received into a question answering module. Herein, the term “query embedding” refers to a numerical vector representation of the user query. Notably, the query embedding captures the meaning of the user query and facilitates to conduct similarity searches that retrieve relevant information related to the query's context. Moreover, when the user enters the user query, the embedder processes the user query to generate a semantic embedding, converting the query text into a dense numerical vector. The embedder, often a model fine-tuned for document analysis tasks, transforms the user query to capture its semantic essence in vector space. It will be appreciated that using embeddings to represent both the user query and the plurality of data chunks improves the ability to match queries to relevant information, capturing meaning beyond exact terms and providing more accurate responses. Additionally, the query embedding enable faster, more efficient similarity-based searches, streamlining the pharmacovigilance data retrieval process and ensuring that the responses are relevant. Moreover, the similarity search is performed on the indexed database to find semantic embeddings of the one or more data chunks that are semantically similar to the user's query. The similarity search evaluates how closely the user's query matches the stored data chunks based on their embedded semantic meanings. It will be appreciated that the similarity search ensures that semantic embeddings of the plurality of data chunks retrieved from the database are contextually relevant to the user's query to prioritize information that best aligns with the query's intended meaning. Furthermore, upon receiving the user query, the dense retriever mechanism initiates a context retriever step that efficiently extracts relevant semantic embeddings from the database based on the nature and specifics of the user query. Furthermore, the dense retriever employs advanced models to sift through the database and identify context that is most pertinent to the user's query. The subject-based user query embeddings represent an additional information or background associated with the subject that provides further meaning, detail, or relevance, in understanding the user's intent more accurately. Typically, the subject-based query embeddings may include specific terms, phrases, related data points, or historical information relevant to the query's subject matter, such as prior adverse events, specific drug or patient information, or other pharmacovigilance-related details. Herein, the term “Factual Evidence (FE) engine” refers to a specialized computational module that is designed to ensure the relevance, accuracy and contextual alignment of retrieved subject-based query embeddings data with respect to the user query. Furthermore, the user query and the context of the retrieved subject-based query embeddings is fed to the FE engine to ensure that the context of the retrieved subject-based query embeddings are aligned with the user query. This increases retrieval accuracy by aligning the user query with its context. It will be appreciated that the FE engine filter out the irrelevant information or irrelevant subject-based query embeddings that minimizes the factual inaccuracies in the automated data analysis process. Furthermore, instead of fetching data one piece at a time, the FE engine retrieves relevant data chunks in batches. This is both time-efficient and computationally effective, as it reduces the overhead associated with repeated single data chunk retrievals, allowing the engine to process larger datasets more swiftly. It will be appreciated that the FE engine ensures that the subject-based query embeddings generated for the user query is not only contextually accurate but also factually reliable. The FE engine plays a critical role in maintaining the integrity of the method's output and enhancing user trust in the automated document analysis process.

In an implementation, the user query embedding and the subject-based query embedding is forwarded to the FE engine in a batch-wise manner. Herein, the FE engine is responsible for accessing the database and retrieving the one or more data chunks associated with the subject-based query embedding and the user query embedding in a batch-wise fashion that allows to gather all relevant pieces of information from the indexed database that could address the user's question or concern. The FE engine processes the retrieved data in a batch-wise manner, meaning the FE engine gathers and examines whether the context of the retrieved subject-based query embeddings aligned with the user query. In a batch-wise manner, the FE engine compare one batch of the subject-based query embeddings with the user query at a time and pass the aligned data in a batch-wise fashion for the downstream analysis. Moreover, the batch processing allows for efficient handling of large datasets, facilitating quicker factual checking of the context of the subject-based query embeddings with respect to the user query and reducing computational load. Furthermore, analysing features in the context of the user query, the FE engine aids in refining the data sent to downstream components, like language models, thereby enhancing the relevance and quality of responses. It will be appreciated that the batch-wise retrieval minimizes database query load, improving data handling for pharmacovigilance datasets and allowing faster response times.

Herein, the term “relevance” refers to the degree to which the retrieved one or more data chunks of the user query embedding and the subject-based query embedding are meaningful and directly related to the user's query. Notably, the relevance ensures that only the information pertinent to the user query is used in the subsequent stages of processing, filtering out any unrelated or low-importance data chunks. Throughout the term “cross encoder” refers to a specialized model within natural language processing (NLP) that compares pairs of text inputs (in this case, the user query and each data chunk) to determine their similarity or relevance. Notably, by encoding both the user query embedding and the subject-based query embedding together, the cross encoder assigns a relevance score that indicates how well each data chunk matches the query's embedding or informational needs. Furthermore, the cross-encoder functions by performing a deeper, more accurate relevance check, as it considers both pieces of text together, rather than encoding them separately. This joint encoding helps the model to capture contextual dependencies and nuances that might not be apparent when each text is processed independently. It will be appreciated that by assigning relevance scores, the cross encoder ensures that only the most contextually fitting data chunks proceed to the response generation stage. This provides an additional layer of quality control, refining the data set and enhancing the accuracy of the final response or summary in the pharmacovigilance process.

In an implementation, the method further comprises using a cross-encoder to rank the plurality of data chunk summaries of the generated summary based on the relevance thereof to the user query. Herein, the cross-encoder is used to rank the plurality of data chunk summaries based on their relevance to the user query. Moreover, the cross-encoder may include assigning a priority of ranking to each data chunk summary amongst the plurality of data chunk summaries, indicating how closely each data chunk summary matches to the user query. Optionally, even after summarizing all the related documents, the user still has doubts about the accuracy of the summarized document. In such scenario, the cross-encoder is part of a Retrieval-Augmented Generation (RAG) framework to evaluate each chunk summary amongst the plurality of chunk summaries by retrieving information and subsequently generates a ranking based on the relevance of each chunk summary to the user query. Optionally, for an example, when a user asked about the prevalence of a specific adverse event in a specific patient demographic. The LLM leverages the context of the user query from previous stages (such as document classification and summarization of the related document). The cross-encoder ranks the plurality of data chunks based on the relevance score thereof and presents the most relevant and accurate data chunks with their relevance score to the user. A technical effect of ranking the plurality of data chunks is to ensure that each evaluated chunk is directly related to the user query. Additionally, the ranking of each chunk summary amongst the plurality of data chunk summaries increases transparency in the summarization process and increases user confidence by providing quantifiable confidence levels to each data chunk related to the summarized adverse effect document. Furthermore, ranking the data chunks based on their relevancy score and presenting the most relevant and accurate data chunk summary at the top, which will improve efficiency and user experience.

Herein, the phrase “verified user query embedding and the subject-based query embedding” refers to the one or more query embeddings that are quantitatively scored by the cross encoder and is selected and confirmed as relevant to the user query. Notably, the query embeddings that meet a defined relevance threshold are passed to the LLM, ensuring that the LLM bases its response on the most contextually accurate and relevant information. Throughout the present disclosure, the term “predefined instruction prompt” refers to a directive or specific set of instructions provided to the large language model (LLM) that guides how the LLM should interpret and process the user query embedding and the subject-based query embedding to generate an accurate response to the user query. Typically, the instruction prompt may include guidelines on the format, style, and context of the response, helping the LLM focus on the specific details required for pharmacovigilance-related answers. Notably, the instruction prompt frames the scope of the response, ensuring the LLM's output is aligned with the intended information needs. For instance, in pharmacovigilance, the prompt might specify that the response should highlight adverse effects, summarize findings concisely, or maintain regulatory-compliant language. Throughout the present disclosure, the term “response” refers to an output that addresses the specific user query, drawing on the context and guidance provided by the instruction prompt. A technical effect approach is enhanced response accuracy, relevance, and contextual alignment in the generated output. By ensuring that only validated, relevant data chunks are passed to the LLM, the computer-implemented method minimizes noise and irrelevant information. Herein, the term “displaying” refers to presenting or visualizing of information on a data management interface. Notably, the displaying makes the generated response from the large language model (LLM) visible and accessible to the user. moreover, the displaying may include presenting the generated response in various forms, such as text, structured data, or graphical formats, depending on the nature of the information and the user's needs. Throughout the present disclosure, the term “user interface” refers to a user facing interface that facilitates the display of information in a structured, readable format, allowing the user to review and interact with the generated response, such as for further analysis or decision-making. Notably, the user interface provides users with tools and functionalities to access generated responses, track data, manage queries, review document summaries, and interact with various outputs.

Herein, the computer-implemented method employs a mechanism to allow the user to interact with and refine the LLM generated response. Moreover, the step allows the user to provide feedback on the response generated by the LLM based on the relevancy score of the generated response, and subsequently, adjust or refine the generated response based on the user's input. A feedback loop is established to receive the user's feedback, processes it, and modifies the generated response to better meet the user's needs, improving the overall quality of the output. Furthermore, the feedback is essential for refining the response generation performance and addressing user-specific needs, contributing to an ongoing cycle of improvement. Furthermore, after the LLM generates the response, the user reviews the response and provides feedback, which could involve pointing out inaccuracies, requesting additional details, or suggesting adjustments based on domain knowledge. Subsequently, iteratively the feedback is processed, and necessary adjustments are made to the generated response. The feedback is used to refine the query or prompt for the LLM, or adjust how data is retrieved and interpreted, based on the feedback's focus (e.g., factual accuracy, clarity, relevance). It will be appreciated that to introduce human-in-the-loop oversight into the automation process, ensuring higher-quality responses that are better aligned with real-world expectations and domain-specific standards. This feedback loop creates an iterative refinement process, allowing to improve the quality and relevance of the generated responses over time.

In an implementation, the computer-implemented method further comprises cross-referencing the response generated by the large language model (LLM) with a corresponding subject-based query embedding, using a factual referencing algorithm; conducting a fact-checking process by comparing the generated response and the user query embeddings; and aligning the generated response with the user query embeddings, when an inconsistency is detected in the comparison. Herein, the term “cross-referencing” refers to a process of comparing or checking the response generated by the large language model (LLM) against the original source of information (i.e., the user query embeddings of the relevant data chunks). Notably, the cross-referencing allows to verify that the LLM's generated response is consistent with the data and factual content contained within the documents. It is an essential step in ensuring that hallucinated or incorrect information is identified and corrected. The subject-based query embeddings represent the source material from which the LLM draws its conclusions or answers, including all relevant and factual content related to the user's query. Notably, the user query embeddings ensures that the generated response is grounded in the right information, making it possible to verify the response's accuracy by matching it to the subject-based query embeddings from which it was derived. Herein, the term “factual referencing algorithm” refers to a set of computational rules or procedures designed to systematically check and validate the factual accuracy of a response generated by the LLM. Herein, the term “fact-checking process” refers to process of comparing the generated response with the user query embeddings to identify any discrepancies or factual errors. Herein, the user query embeddings represent a specific background information, conditions, or details relevant to the user query at the time it was received. Notably, the original context helps establish a baseline of information that the large language model (LLM) uses to generate a response. This includes not just the question itself but the surrounding facts and conditions from prior communications or documents. The factual referencing algorithm works by comparing the generated response with the original context of the user query to identify any discrepancies or factual errors. The comparison may involve verifying that the information provided by the LLM aligns with known facts, data, or specific details provided in the original context, aiming to identify and correct inconsistencies or errors. Moreover, the factual referencing algorithm automates the process of fact-checking by cross-referencing the LLM outputs with the factual information stored in the embeddings. It highlights any inconsistencies, contradictions, or potential errors, ensuring that only factually correct responses are provided to the user. it will be appreciated that the fact-checking process ensures that any responses provided in high-stakes environments (like pharmacovigilance) are not only linguistically coherent but also factually sound, which is critical for domains where precise, trustworthy information is required. Furthermore, in case of any inconsistencies, the generated response is aligned with the user query embeddings to ensure accuracy and trustworthiness of the response generated. A technical effect is to minimize the risk of errors and increases the accuracy and reliability of the responses generated by the LLM. This approach reduces the reliance on manual intervention and enables automated, robust validation of generated responses, making the process more efficient, scalable, and trustworthy. Additionally, the fact-checking process traces generated responses back to their source within the document, providing verifiable citations and enhancing user trust and confidence. Optionally, for an example, question arose about the causal relationship between a specific drug and a reported adverse event. The LLM returned a “likely causal” response, it also provided direct links and excerpts from specific sections of the original case report supporting this assessment. This enhanced transparency and significantly increased confidence in the LLM's conclusions.

In an implementation, the method further comprises updating the document classifier and similarity search module based on the user feedback. Herein, the term “updating” refers to a process of modifying or adjusting the functionality, parameters or the data of the document classifier and similarity search module in response to the user feedback. Notably, the updating may include tweaking model parameters, weights, or thresholds within the document classifier and similarity search module to improve their performance based on the feedback received. Moreover, the updating may include re-training the document classifier and the similarity search module using the data or insights gathered from the user feedback, enabling them to better reflect the concerns expressed by the user. furthermore, updating may include changing the underlying rules. A technical effect of updating the document classifier and similarity search module based on the user feedback is that the document classifier becomes better at distinguishing between true adverse effects and irrelevant data, reducing false positives and negatives. Additionally, the similarity search module retrieves more contextually relevant cases, aiding in quicker identification and validation of related information.

In an implementation, the method further comprises generating the summary in a predefined format. Herein, the term “predefined format” refers to a structured format or template for presenting the summary that aligns with standards and requirements mandated by the regulatory authorities such as health, safety, industry-specific agencies and the like. Notably, the predefined format may include specific guidelines for data presentation, terminology, and content arrangement to ensure compliance with established protocols. For example, in the field of pharmacovigilance, the regulatory format may be designed to conform to protocols set by agencies like the Food and Drug Administration (FDA), European Medicines Agency (EMA), or other health regulatory bodies, which specify how adverse events or drug safety reports must be documented and coded.

In an implementation, the contextual information comprises at least one of: a metadata, a specific field, a section relevant to the target document. Herein, the at least one of one of: metadata, a specific field, a section relevant to the target document specifies the types of supporting information that may be retrieved for the given document. The contextual information enhances the understanding and processing of the content of the target document, allowing for targeted and relevant responses to the user query. Moreover, the metadata may include document attributes like date, author, or classification. The specific field may include effect of drugs on pregnant women and relevant sections might include content segments directly related to the focus of the user query. A technical effect of incorporating varied contextual information is a more accurate, relevant, and streamlined document processing workflow that increases processing speed, reduces the likelihood of irrelevant data being included in the output, and contributes to a higher quality and compliance-ready document summarization.

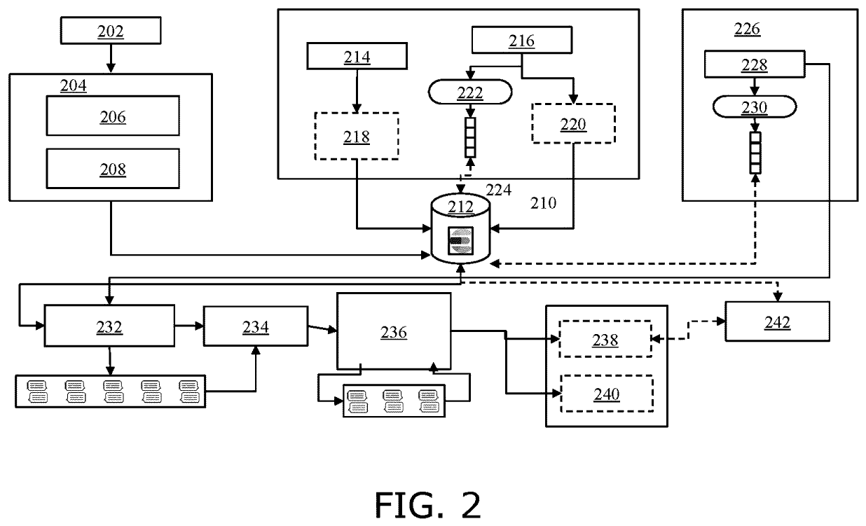

FIG. 2 is flowchart depicting an exemplary scenario for automating a document analysis process 200, in accordance with an embodiment of the present disclosure. A plurality of documents 202 is received into a document classification module 204 based on a user input. A document classifier 206 processes each document from amongst the plurality of documents to classify each document into a related document or an unrelated document, based on information present in each document. When a given document is classified as the related document, at step 208, the given document is divided into a plurality of data chunks comprising text portions and using a transformer-based language model, semantic embeddings for each data chunk of the plurality of data chunks is generated. At step 210, the plurality of data chunks and the corresponding semantic embeddings is indexed, in a database 212. A document identifier 214 corresponding to a target document and a subject 216 is received for summarization in a summarization module. Optionally, at step 218, query for document identifier is generated. optionally, at step 220, query for text match is generated. An embedder 222 generates a subject-based query embedding of the subject 216. At step 224, a similarity search is performed in the database 212 to retrieve at least one data chunk related to the subject 216 from amongst the plurality of data chunks. In a question answering module 226, a user query 228 is forwarded to an embedder 230 to generate a user query embedding and to perform a similarity search of the user query embedding in the database 212 to retrieve semantic embeddings of the at least one or more data chunk related to the user query 228. At step 232, the user query embedding and the subject-based query embedding from the database 212 is forwarded to a Factual Evidence (FE) engine 234. The verified user query embedding and the subject-based query embedding along with a predefined instruction prompt is passed to at least one LLM 236 to generate a response 238 of the user query 238 and a summary 240 for the subject 216. The generate response 238 is verified using a cross encoder 242 and the generated response 238 along with the relevancy score is displayed to the user. Optionally, the plurality of documents 202 is categorized into the related or unrelated document via the document classifier 206. The classification module 204 comprises document classifier 206 that classify the received plurality of documents 202 for downstream processes like chunk generation 208 and indexing at step 210. The database 212 stores the plurality of data chunks and the semantic embeddings generated at step 210, enables retrieval during the similarity search at step 224, and for the user query 228 processing. Moreover, the embedder 222 generates query embeddings for the subject 216 allows similarity search at step 224, in the database 212. The summary 240 generated by the LLM 236 for the subject 216 displayed to the user. Furthermore, the cross encoder 242 verifies the relevance of the response 238 generated by the LLM 236.

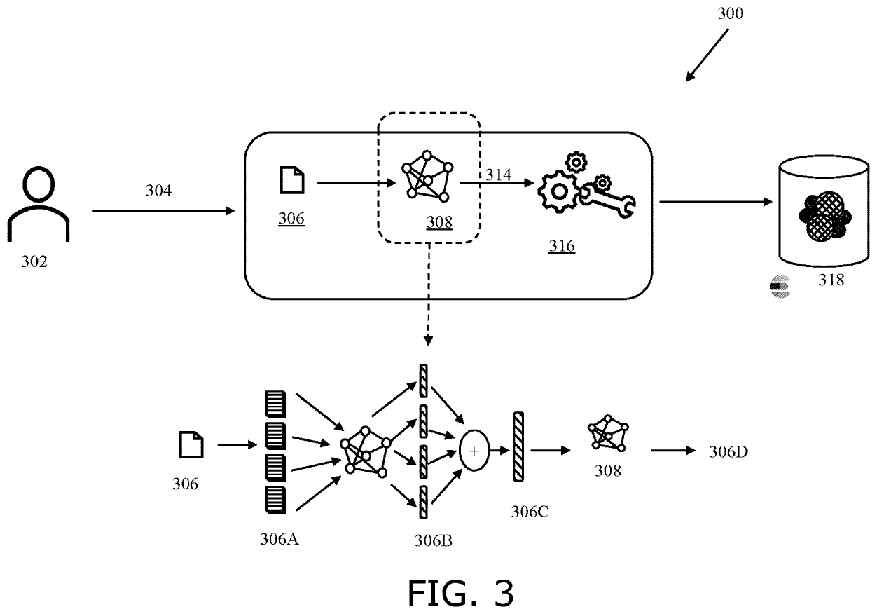

FIG. 3 is a schematic illustration of an exemplary scenario of a document classification 300, in accordance with an embodiment of the present disclosure. At step 304, receiving a document 306 based on a user 302 input into to a document classification module 308. Moreover, processing the document 306 using a document classifier 310 to classify the document 306 into a related document or an unrelated document, based on information present in the document 306. At step 312, when the document 306 is classified as the related document. At step 314, the given document is segmented into a plurality of data chunks comprising text portions and, using a transformer-based language model, semantic embeddings for each data chunk of the plurality of data chunks is generated. At step 316, the plurality of data chunks and the corresponding semantic embeddings thereof, is indexed in a database 318. Optionally, during the preprocessing, the document 306 is divided into small manageable units such as small paragraphs of text portions 306A. the small paragraphs are converted into dense vector representations or paragraph embeddings 306B. The paragraph embeddings are mean pooled to generate the document embeddings 306C. the document embeddings are received by the document classifier to predict binary levels 306D such as 0 or 1.

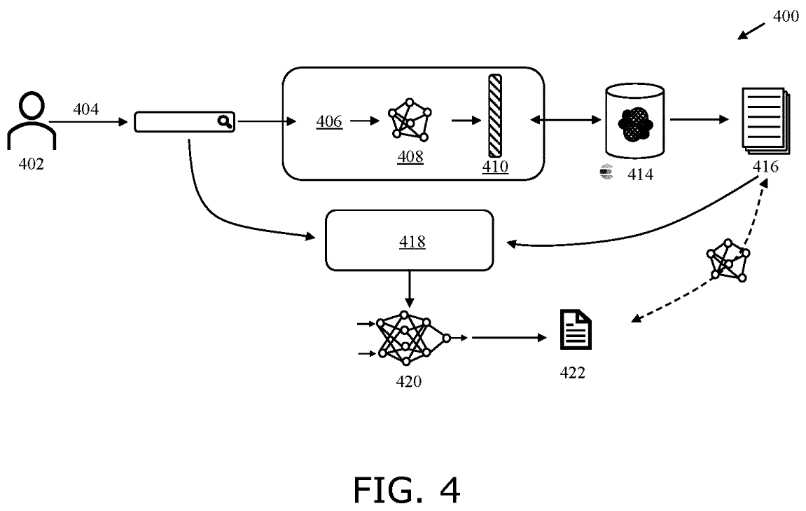

FIG. 4 is schematic illustration of an exemplary scenario of a question-answering process 400, in accordance with an embodiment of the present disclosure. As shown in FIG. 4, at step 404, a user query 406 is received from the user 402. Moreover, a user query embedding 410 using an embedder 408. At step 412, a similarity search of the user query embedding 410 is performed in the database 414 to retrieve semantic embeddings 416 of the at least one data chunk related to the user query 406. At step 418, forwarding the semantic embeddings 416 of the at least one data chunk, the user query 406 and a predefined instruction prompt is forwarded from the database 414 to at least one LLM 420 to generate a response 422 for the user query 406. Furthermore, a cross encoder 424 verifies the relevance of the response 422 generated by the at least one LLM 420.

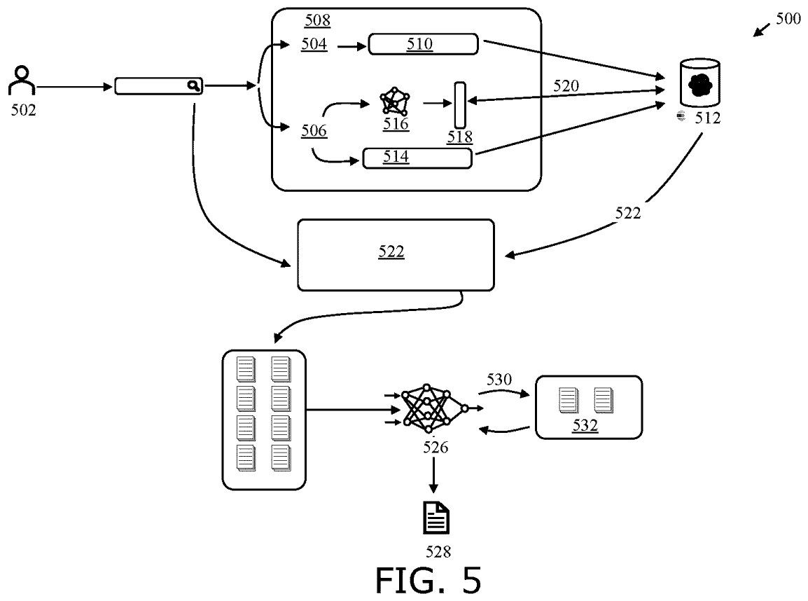

FIG. 5 is a schematic illustration of an exemplary scenario of summarization 500, in accordance with an embodiment of the present disclosure. As shown in FIG. 5, a user 502 submits at least one of: a document identifier 504, a subject 506 in a summarization module 508. At step 510, a query for document identifier 504 match is generated in the database 512. At step 514, a query for text match is generated in the database 512. Moreover, an embedder 516 generates a subject-based query embedding 518 of the subject 506. At step 520, a similarity search is performed in the database 512. At step 522, the semantic embeddings of the at least one data chunk is retrieved. At step 524, the retrieved semantic embeddings of the at least one data chunk, the query and at least one instruction is passed to at least one large language model (LLM) 526 to generate a summary 528. At step 530, the LLM 526 generate summaries 532 of the semantic embeddings of each data chunk of the plurality of data chunks.

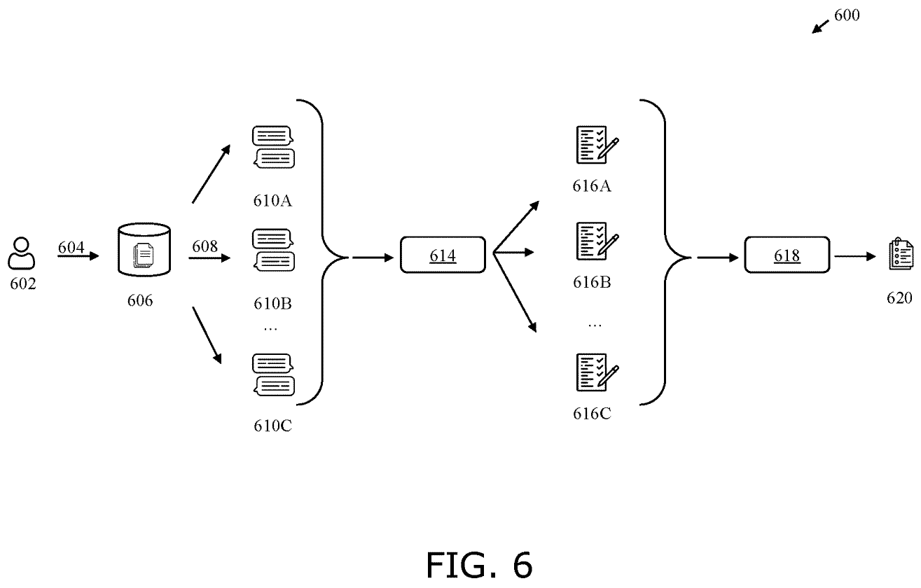

FIG. 6 is a schematic illustration depicting steps of an exemplary scenario of a document-based summarization 600, in accordance with an embodiment of the present disclosure. At step 604, the user 602 enters the document identifier. Moreover, the target document corresponding to the document identifier is retrieved from the database 606. At step 608, the target document is segmented into the plurality of data chunks 610A-C comprising text portions of the target document. At step 612, the plurality of data is passed to the LLM 614 to generate corresponding plurality of chunk summaries 616A-C thereof. The plurality of chunk summaries 616A-C is aggregated using the LLM 618 to generate a summary 620 of the target document corresponding to the document identifier.

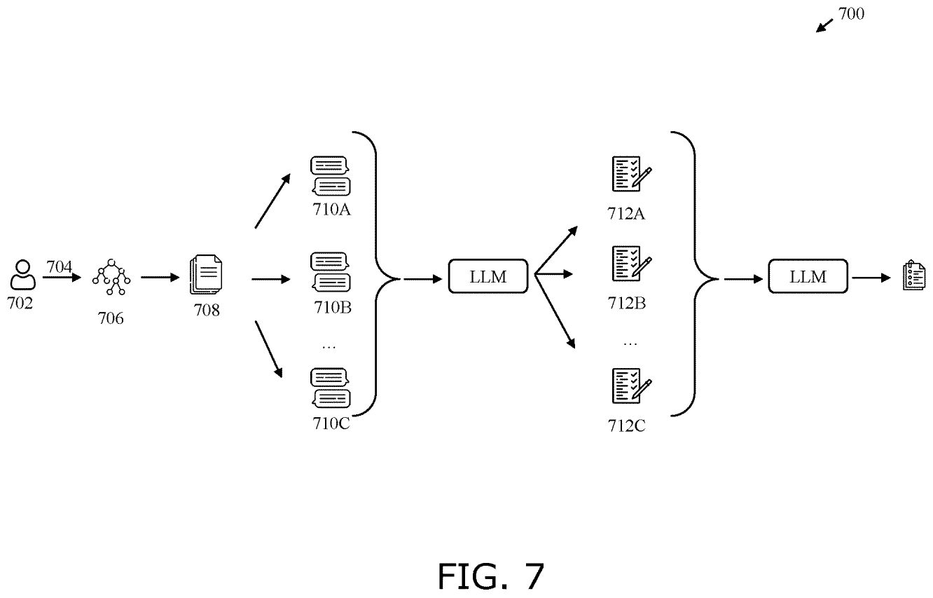

FIG. 7 is a schematic illustration depicting steps of an exemplary scenario of a subject-based summarization 700, in accordance with an embodiment of the present disclosure. At step 704, the user 702 enters a subject. A subject-based query embedding 706 of the subject is generated. A similarity search of the subject-based query embedding and text matching of the subject is performed to retrieve context 708 of the subject from the database. The retrieved context of the subject is converted into the plurality of data chunks 710A-C. Furthermore, the plurality of data chunks 710A-C of the retrieved context is passed to the LLM to generate individual summaries 712A-C of the plurality of data chunks of the retrieved context. Subsequently, the individual summaries 712A-C is passed to the LLM to generate a summary 714 of the subject.

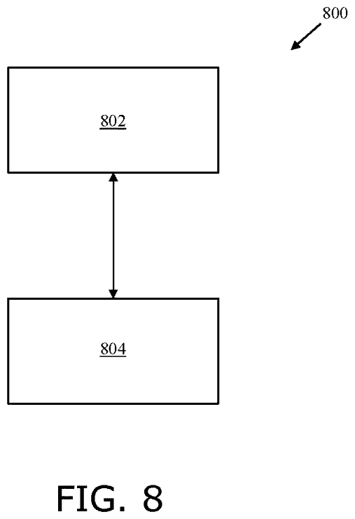

FIG. 8 is schematic implementation of a system 800 for automating document analysis process, in accordance with an embodiment of the present disclosure. As shown in FIG. 8, the system 800 comprises at least one processor 802 communicably coupled to a user device 804. The processor 802 is configured to receive a plurality of documents based on a user input, into a document classification module. Moreover, the processor 802 is configured to process each document from amongst the plurality of documents using a document classifier to classify each document into a related document or an unrelated document, based on information present in each document. Furthermore, the processor 802, when a given document is classified as the related document, is configured to segment the given document into a plurality of data chunks comprising text portions. Furthermore, the processor 802 is configured to generate, using a transformer-based language model, semantic embeddings for each data chunk of the plurality of data chunks. Furthermore, the processor 802 is configured to index the plurality of data chunks and the corresponding semantic embeddings thereof, in a database. Furthermore, the processor 802 is configured to retrieve the semantic embeddings of the plurality of data chunks for summarizing the given document based on at least one of: a document identifier, a subject. Furthermore, the processor 802 is configured to generate a subject-based query embedding of the subject. Furthermore, the processor 802 is configured to perform a similarity search of the subject-based query embedding in the database to retrieve semantic embeddings of the at least one data chunk related to the subject. Furthermore, the processor 802 is configured to pass the retrieved semantic embeddings of the at least one data chunk to at least one large language model (LLM), to generate a summary of the given document, based on the subject.

Herein, the term processor 802 refers to a computational element that is operable to execute the software framework. Examples of the processor 802 include, but are not limited to, a microprocessor, a microcontroller, a complex instruction set computing (CISC) microprocessor, a reduced instruction set (RISC) microprocessor, a very long instruction word (VLIW) microprocessor, or any other type of processing circuit. Furthermore, the processor 802 may refer to one or more individual processors, processing devices and various elements associated with a processing device that may be shared by other processing devices. Additionally, one or more individual processors, processing devices and elements are arranged in various architectures for responding to and processing the instructions that execute the software framework.

Modifications to embodiments of the present disclosure described in the foregoing are possible without departing from the scope of the present disclosure as defined by the accompanying claims. Expressions such as “including”, “comprising”, “incorporating”, “have”, “is” used to describe, and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments and/or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the present disclosure, which are, for brevity, described in the context of a single embodiment, may also be provided separately or in any suitable combination or as suitable in any other described embodiment of the disclosure.

What is claimed is:

1. A computer-implemented method for automating document analysis process, comprising:
receiving a plurality of documents based on a user input, into a document classification module;
processing each document from amongst the plurality of documents using a document classifier to classify each document into a related document or an unrelated document, based on information present in each document;
when a given document is classified as the related document:
segmenting the given document into a plurality of data chunks comprising text portions,
generating, using a transformer-based language model, semantic embeddings for each data chunk of the plurality of data chunks,
indexing the plurality of data chunks and the corresponding semantic embeddings thereof, in a database,
retrieving the semantic embeddings of the plurality of data chunks for summarizing the given document based on at least one of: a document identifier, a subject,
generating a subject-based query embedding of the subject,
performing a similarity search of the subject-based query embedding in the database to retrieve semantic embeddings of the at least one data chunk related to the subject,
and
passing the retrieved semantic embeddings of the at least one data chunk to at least one large language model (LLM), to generate a summary of the given document, based on the subject.

2. The computer-implemented method of claim 1, further comprising:
receiving a user query from the user;
generating a user query embedding;
performing a similarity search of the user query embedding in the database to retrieve semantic embeddings of the at least one data chunk related to the user query;
forwarding the user query embedding and the subject-based query embedding from the database to a Factual Evidence (FE) engine;
verifying a relevance of the user query embedding and the subject-based query embedding using a cross encoder;
passing the verified user query embedding and the subject-based query embedding along with a predefined instruction prompt to at least one LLM to generate a response for the user query;
displaying the generated response to the user via a user interface; and
enabling the user to provide, via the user interface, a feedback to the LLM for adjusting the generated response based on the feedback.

3. The computer-implemented method of claim 1, further comprising:
receiving the document identifier corresponding to a target document;
retrieving the target document associated with the document identifier from the database, using a dense retriever;
segmenting the target document into a plurality of data chunks comprising text portions;
passing the plurality of data chunks to the LLM to generate corresponding plurality of data chunk summaries thereof;
aggregating the plurality of data chunk summaries to generate a summary in a predetermined format, using the LLM; and
displaying the generated summary in the predetermined format as an output to the user; and receiving a user feedback to the output.

4. The computer-implemented method of claim 2, wherein the user query embedding and the subject-based query embedding is forwarded to the FE engine in a batch-wise manner.

5. The computer-implemented method of claim 1, wherein when a given document is classified as the unrelated document, the method comprises discarding the unrelated document.

6. The computer-implemented method of claim 2, further comprising:
cross-referencing the response generated by the large language model (LLM) with a corresponding subject-based query embedding, using a factual referencing algorithm;
conducting a fact-checking process by comparing the generated response and the user query embeddings; and
aligning the generated response with the user query embeddings, when an inconsistency is detected in the comparison.

7. The computer-implemented method of claim 6, further comprising using the cross-encoder to rank the plurality of data chunk summaries of the generated response based on the relevance thereof to the user query.

8. The computer-implemented method of claim 1, further comprising updating the document classifier and similarity search module based on a user feedback.

9. The computer-implemented method of claim 1, wherein the document classifier comprises a machine learning model to classify each document into the related document or the unrelated document.

10. The computer-implemented method of claim 3, further comprising generating the summary in a predefined format.

11. The computer-implemented method of claim 3, wherein the contextual information comprises at least one of: a metadata, a specific field, a section relevant to the target document.

12. A system for automating document analysis process, comprising at least one processor configured to:
receive a plurality of documents based on a user input, into a document classification module;
process each document from amongst the plurality of documents using a document classifier to classify each document into a related document or an unrelated document, based on information present in each document;
when a given document is classified as the related document:
segment the given document into a plurality of data chunks comprising text portions,
generate, using a transformer-based language model, semantic embeddings for each data chunk of the plurality of data chunks,
index the plurality of data chunks and the corresponding semantic embeddings thereof, in a database,
retrieve the semantic embeddings of the plurality of data chunks for summarizing the given document based on at least one of: a document identifier, a subject,
generate a subject-based query embedding of the subject,
perform a similarity search of the subject-based query embedding in the database to retrieve semantic embeddings of the at least one data chunk related to the subject,
and
pass the retrieved semantic embeddings of the at least one data chunk to at least one large language model (LLM), to generate a summary of the given document, based on the subject.

13. The system of claim 12, wherein the at least one processor is further configured to:
receive a user query from the user;
generate a user query embedding;
perform a similarity search of the user query embedding in the database to retrieve semantic embeddings of the at least one data chunk related to the user query;
forward the user query embedding and the subject-based query embedding from the database to a Factual Evidence (FE) engine;
verify a relevance of the user query embedding and the subject-based query embedding using a cross encoder;
pass the verified user query embedding and the subject-based query embedding along with a predefined instruction prompt to at least one LLM to generate a response for the user query;
display the generated response to the user via a user interface; and
enable the user to provide, via the user interface, a feedback to the LLM for adjusting the generated response based on the feedback.

14. The system of claim 12, wherein the at least one processor is further configured to:
receive the document identifier corresponding to a target document;
retrieve contextual information associated with the document identifier from the database, using a dense retriever;
segment the contextual information into a plurality of data chunks comprising text portions of the target document;
pass the plurality of data chunks to the LLM to generate corresponding plurality of chunk summaries thereof;
aggregate the plurality of data chunk summaries to generate a summary in a predetermined format, using the LLM; and
display the generated summery in the predetermined format as an output to the user; and receiving a user feedback to the output.

15. The system of claim 13, wherein the at least one processor is further configured to forward the user query embedding and the subject-based query embedding to the FE engine in a batch-wise manner.

16. The system of claim 12, wherein when a given document is classified as the unrelated document, the wherein the at least one processor is further configured to discard the unrelated document.

17. The system of claim 13, wherein the at least one processor is further configured to:
cross-reference the response generated by the large language model (LLM) with a corresponding subject-based query embedding, using a factual referencing algorithm;
conduct a fact-checking process by comparing the generated response and the user query embeddings; and
align the generated response with the user query embeddings, when an inconsistency is detected in the comparison.

18. The system of claim 17, wherein the at least one processor is further configured to use a cross-encoder to rank the plurality of data chunk summaries of the generated response based on the relevance thereof to the user query.

19. The system of claim 12, wherein the at least one processor is further configured to update the document classifier and similarity search module based on the user feedback.

20. The system of claim 12, wherein the at least one processor is further configured to generate the summary in a predefined format.
